(19) United States
(12) Patent Application Publication
(10) Pub. No.: US 2003/0200243 A1
(43) Pub. Date: Oct. 23, 2003

(54) Finite impulse response filter, communication transmission apparatus and communication reception apparatus

(75) Inventors: Hidekuni Yomo, Kawasaki-shi (JP); Yuuri Yamamoto, Tokyo (JP); Yoshinori Kunieda, Sagamihara-shi (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 10/409,050

(22) Filed: Apr. 9, 2003

(30) Foreign Application Priority Data
Apr. 19, 2002 (JP) JP2002-117269

(51) Int. Cl. G06F 17/10

(52) U.S. Cl. 708/306

(57) ABSTRACT

Wiring is variably connected between delay section 102 having N delay elements, D0 to DN-1, and multiplying section 104 having N multipliers, c(0) to c(N-1). Further, wiring is variably connected between multiplying section 104 and adding section 106 having N adders, K0 to KN-1. When the oversampling number of an input signal is dynamically varied, wiring control section 109 varies the wiring so as to obtain a filter structure with a number of parallels corresponding to the oversampling number. Thus, the finite impulse response filter is capable of responding to the dynamically varied oversampling number, and reducing its circuit size.

### BACKGROUND OF THE INVENTION

1. Field of the Invention

The present invention relates to a finite impulse response filter for filtering discrete signals, and is suitable for use in band-limitation filter in a single-carrier radio transmission apparatus that performs linear modulation such as BPSK, QPSK and QAM.

2. Description of the Related Art

In general, finite impulse response (FIR) filters are sorted to some types in terms of connection manner of delay elements, multipliers and adders. Among them, direct FIR filters and transposed FIR filters are used widely. Structures of the filters will be described briefly with reference to accompanying drawings. FIG. 1 is a block diagram illustrating a structure of a direct FIR filter. Delay elements 11a to 11e are connected in series, and delay an input signal until a next signal is input. The delayed signal is output to a subsequent delay element and a multiplier. Multipliers 12a to 12e are set for respective tap coefficients in advance, and multiply signals output from respective delay elements by respective tap coefficients, and output multiplication results to adder 13. Adder 13 adds all the multiplication results output from multipliers 12a to 12e, and outputs an addition result.

FIG. 2 is a block diagram illustrating a structure of a transposed FIR filter. Multipliers 21a to 21e are set for respective tap coefficients in advance, and multiply a same input signal by respective tap coefficients, and outputs multiplication results to adders 22a to 22e, respectively. Adders 22a to 22e are respectively connected to multipliers 21a to 21e. Each of the adders adds a multiplication result from a multiplier and a delayed signal from a delay element, and outputs a multiplication result to a subsequent delay element. Each of delay elements 23a to 23d delays a multiplication result output from respective one of adders 22a to 22e until next multiplication result is input. The delayed signal is output to a subsequent adder.

Conventionally, in order to reduce these circuit sizes, there is a technique disclosed in Japan Patent Publication 2929807 which uses data signals not subjected to band limitation as input signals.

Further, Japan Laid-Open Patent Publication 2001-77669 describes a technique that reduces a circuit size by switching multiplication coefficients, as well-known.

Meanwhile, as measures for decreasing calculation operation speed required for oversampling, there is known a technique described in Japan Laid-Open Patent Publication S60-77542. The subject matter of the technique will be described briefly with reference to FIG. 3. FIG. 3 is a block diagram illustrating a structure of a conventional FIR filter. Blocks 31a to 31d each have the same structure as that of the direct FIR illustrated in FIG. 1, and are connected in parallel to one another. Tap coefficients of respective multipliers are set so as to separately calculate tap coefficients corresponding to different phases. Multiplexing section 32 multiplexes calculation results of blocks 31a to 31d to output a multiplexed signal. Thus, each block is capable of processing an input signal in parallel, and it is possible to execute filtering at precision four times the oversampling number. In other words, when implementing the filtering precision in the structure in FIG. 3 by the structure in FIG. 1, the calculation operation speed required for the oversampling is four times the calculation operation speed required for the case of FIG. 3. Accordingly, by constructing direct FIR filters in parallel as illustrated in FIG. 3, it is possible to decrease the calculation operation speed required for oversampling.

However, in order to achieve an FIR filter corresponding to the oversampling number dynamically varied, it is required to prepare a plurality of filters corresponding to each oversampling number, using the method illustrated in FIG. 3. For example, in order to prepare two-parallel, four-parallel and eight-parallel filters, fourteen filters are required and switched to use, resulting in increases in circuit size.

### SUMMARY OF THE INVENTION

It is an object of the present invention to provide a finite impulse response filter, communication transmission apparatus and communication reception apparatus which correspond to dynamically varied oversampling numbers and reduce the circuit size.

The subject matter of the present invention is that wiring of predetermined numbers of delay elements and multipliers, and wiring of predetermined multipliers and adders is variably connected, and when the oversampling number of an input signal is dynamically varied, the wiring is varied so as to obtain a filter structure with a number of parallel filters corresponding to the oversampling number.

### BRIEF DESCRIPTION OF THE DRAWINGS

The above and other objects and features of the invention will appear more fully hereinafter from a consideration of the following description taken in connection with the accompanying drawing wherein one example is illustrated by way of example, in which;

FIG. 1 is a block diagram illustrating a structure of a direct finite impulse response filter;

FIG. 2 is a block diagram illustrating a structure of a transposed finite impulse response filter;

FIG. 3 is a block diagram illustrating a structure of a conventional finite impulse response filter;

FIG. 4 is a block diagram illustrating a structure of a finite impulse response filter according to a first embodiment of the present invention;

FIG. 5A is a diagram illustrating wiring of a two-parallel filter structure;

FIG. 5B is another diagram illustrating wiring of the two-parallel filter structure;

FIG. 6A is a diagram illustrating wiring of a four-parallel filter structure;

FIG. 6B is another diagram illustrating wiring of the two-parallel filter structure;

FIG. 7A is a view illustrating the relationship between the oversampling number and aliasing;

FIG. 7B is another view illustrating the relationship between the oversampling number and aliasing;

FIG. 7C is another view illustrating the relationship between the oversampling number and aliasing;

FIG. 7D is another view illustrating the relationship between the oversampling number and aliasing;

FIG. 8 is a block diagram illustrating a configuration of a communication reception apparatus according to the first embodiment of the present invention;

FIG. 9 is a block diagram illustrating an internal configuration of a phase determining section according to the first embodiment of the present invention;

FIG. 10 is a block diagram illustrating a structure of a finite impulse response filter according to a second embodiment of the present invention;

FIG. 11 is a view illustrating wiring of a first wiring variable port and second wiring variable port, and connection state of a connecting section;

FIG. 12 is another view illustrating wiring of the first wiring variable port and second wiring variable port, and connection state of the connecting section;

FIG. 13 is a block diagram illustrating a structure of a finite impulse response filter according to a third embodiment of the present invention;

FIG. 14 is a block diagram illustrating another structure of a finite impulse response filter according to the third embodiment of the present invention;

FIG. 15 is a block diagram illustrating a configuration of a communication reception apparatus according to a fourth embodiment of the present invention;

FIG. 16 is a block diagram illustrating a configuration of a quadrature signal reception apparatus according to a fifth embodiment of the present invention;

FIG. 17 is a conceptual view illustrating a base station transmitting signals to mobile stations at symbol rates corresponding to moving or stopping;

FIG. 18 is a block diagram illustrating a configuration of a communication reception apparatus according to a seventh embodiment of the present invention; and

FIG. 19 is a schematic view illustrating signals output from a switching section according to the seventh embodiment of the present invention.

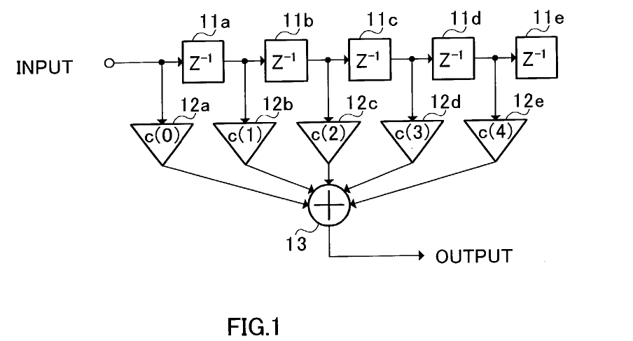

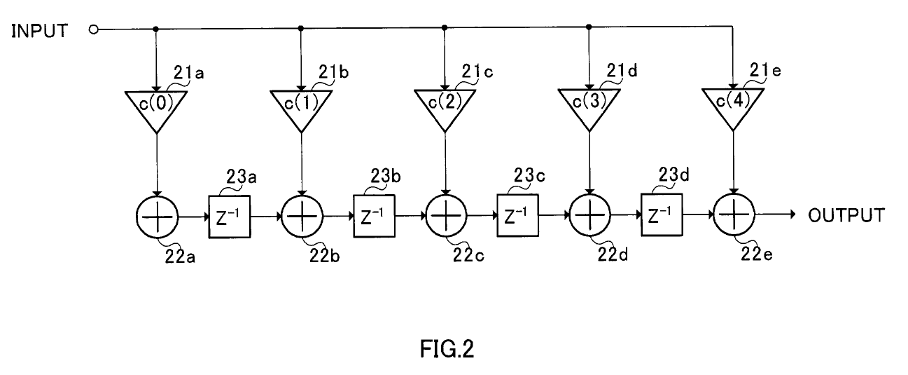

### DETAILED DESCRIPTION OF THE PREFERRED EMBODIMENTS

Embodiments of the present invention describe the case where a finite impulse response filter is applied to a communication apparatus. Conventionally, a predetermined frequency bandwidth is only used, and in order to increase the transmission rate while ensuring desired communication quality, adaptive modulation is performed. However, since a predetermined frequency bandwidth is only used, there are limitations in improving the transmission rate. Therefore, the embodiments of the present invention describe a case where the frequency bandwidth is variable to increase the transmission rate.

In making a signal frequency bandwidth variable, when a bandwidth of a filter is only varied with a symbol rate of input signal maintained at a constant value, a variable range of the signal bandwidth is narrow. Therefore, it is also required to make the symbol rate variable. In order to ensure excellent communications in response to variations in symbol rate, it is necessary to vary a bandwidth of a filter corresponding to the variations in symbol rate. In addition, increasing the symbol rate results in a wider-bandwidth signal, while decreasing the symbol rate results in a narrower-bandwidth signal.

In general, the bandwidth of a filter is varied by varying tap coefficients of the filter or varying a sampling frequency. Meanwhile, a large number of filter taps are required to obtain steep attenuation characteristics. Therefore, when the sampling frequency is constant, it is difficult to implement a wide-bandwidth FIR filter only by varying tap coefficients. Further, the constant sampling frequency also means the varying oversampling number, and the increasing oversampling number becomes over specification when a signal has a low symbol rate (narrow-bandwidth signal), resulting only in excessive power consumption.

Meanwhile, it is considered varying the sampling frequency corresponding to the symbol rate. In other words, when the symbol rate is doubled, the sampling frequency is also doubled proportionally. In this way, it is possible to maintain the oversampling number at a constant value even when the symbol rate is varied, and it is not required to prepare excessive specifications with respect to signals of low symbol rate and to reduce excessive power consumption.

However, when the sampling frequency is increased, it is not possible to perform adequate filtering on signals of high symbol rate due to limitations in operable frequency of a sampling device such as, for example, an A/D converter and a filtering circuit disposed subsequent to the device.

For example, note a route roll-off filter as described below. A case is assumed that the oversampling number is 16, the operable frequency of a sampling device or a filtering circuit disposed subsequent to the device is 160 MHz and the roll-off rate a indicative of frequency characteristics of a filter is 1.0. In this case, the symbol rate that the route roll-off filter is capable of processing is limited to 10 MHz. On the assumption that it is possible to connect an ideal analog filter upstream from the sampling device to perform bandwidth limitation to half the sampling frequency, it is theoretically possible to execute filtering processing on signals with symbol rates of up to 80 MHz meeting the nyquist theorem.

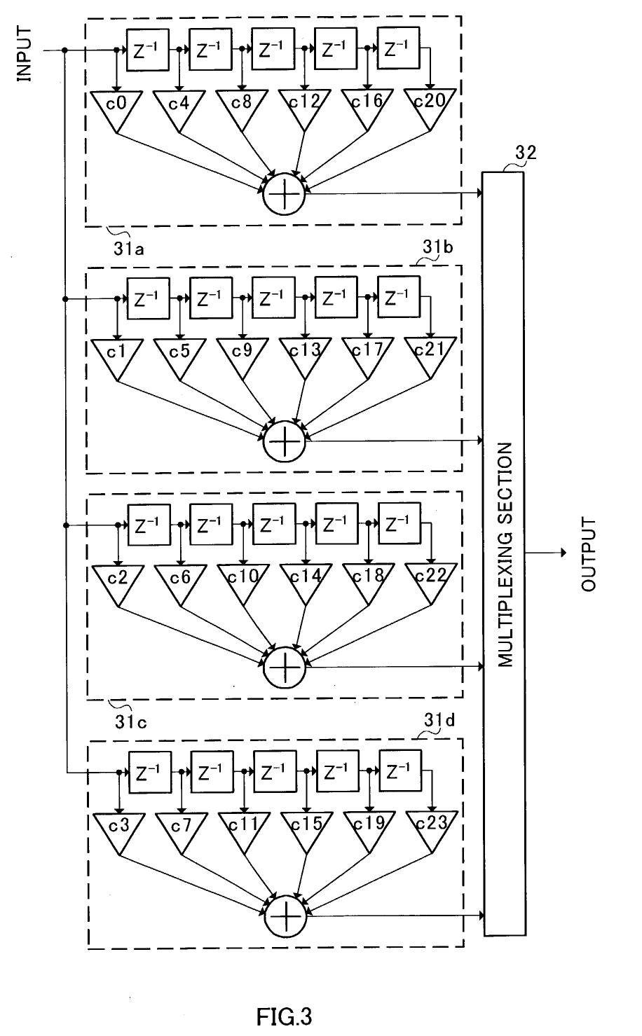

In other words, when the sampling frequency is 160 MHz, 2-times oversampling is performed and filters subsequent to the sampling device are constructed in eight-parallel using the method as illustrated in FIG. 3, the sampling device operating at 2-times oversampling is capable of obtaining the filter processing precision equivalent to 16-times oversampling.

In addition, when the above-mentioned parallel constructed filters are used in a reception apparatus in radio communications, an input signal is a discrete signal by 2-times oversampling, thereby has a low possibility of meeting the nyquist theorem, and tends to be affected by aliasing by the sampling. As a result, there occurs deterioration in reception performance due to adjacent channel interference. In particular, in the case of narrow-bandwidth transmission, since the adjacent channel interference is large because improvements in the spectral efficiency are required, the resistance to the interference is greatly desired.

Meanwhile, in wide-bandwidth transmission, even no adjacent channel interference, limitations in processing speed due to restrictions of devices are general issues, and it is necessary to resolve the issues due to the processing speed.

Then, it is considered executing processing as described below. That is, with respect to signals of low symbol rate transmitted during moving, since the adjacent channel interference becomes a problem, sufficiently fast sampling frequency, for example, 16-times oversampling is performed to prevent occurrences of deterioration due to adjacent channel interference. Meanwhile, with respect to signals of high symbol rate transmitted during stopping, 2-times oversampling is performed to receive signals of symbol rate executable up to an upper limit of the operable frequency of devices, while allowing deterioration due to adjacent channel interference to some extent. In the case of executing such processing, it is required to decrease the oversampling number stepwise from 16-times to 8-times, 4-times and 2-times in terms of the relationship between increases in frequency bandwidth and operable frequency of device.

Accordingly, in conventional techniques, since the oversampling number is kept constant and the sampling frequency is varied, it is difficult to maximize performance of filters, while minimizing effects of adjacent channel interference. On the contrary, the present invention provides a finite impulse response filter that responds to dynamically varied oversampling numbers with the sampling frequency kept constant, and thereby aims to maximize performance of the filter, while minimizing effects of adjacent channel interference.

Embodiments of the present invention will be described below specifically with reference to accompanying drawings.

(First Embodiment)

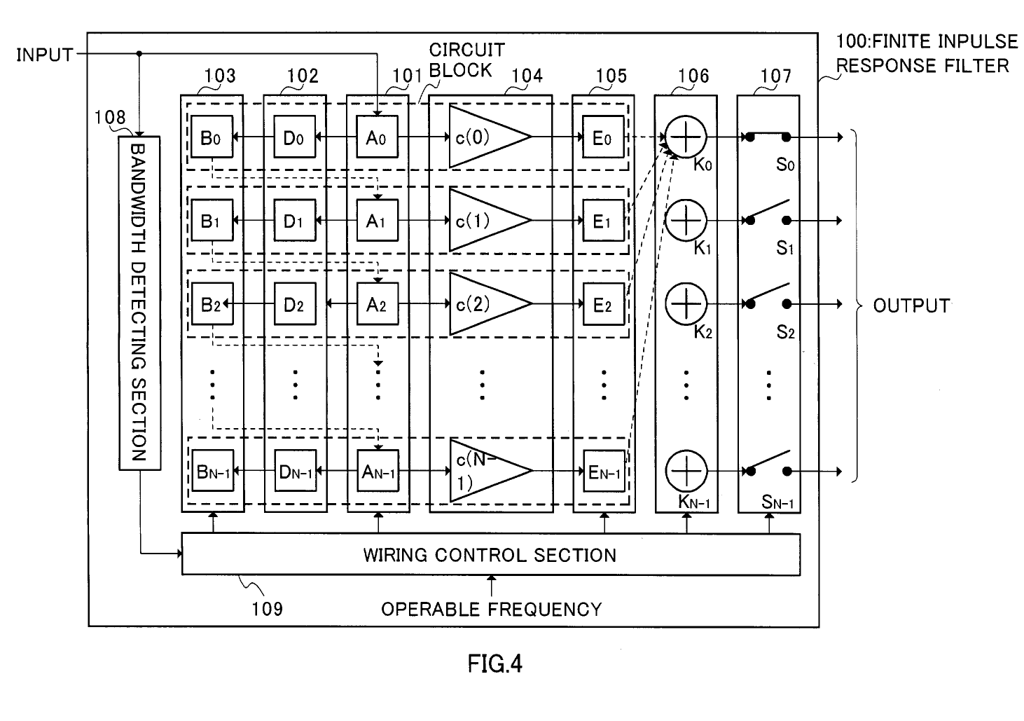

FIG. 4 is a block diagram illustrating a structure of a finite impulse response filter according to the first embodiment of the present invention. Finite impulse response (FIR) filter 100 performs convolutional calculation of N-tap finite impulse response sequence.

First wiring variable port 101 has N terminals, A0 to AN-1, enabling variable wiring. Delay section 102 has delay elements D0 to DN-1 with a delay time that is a sampling period. Second wiring variable port 103 has N terminals, B0 to BN-1, enabling variable wiring.

Multiplying section 104 has N multipliers, c(0) to c(N-1), and each multiplier is set in advance for a tap coefficient of finite impulse response sequence. Each multiplier multiplies a signal output from the first wiring variable port by the tap coefficient. Third wiring variable port 105 has N terminals, E0 to EN-1, enabling variable wiring. In addition, combinations of delay elements, multipliers and terminals are assumed to be circuit blocks and enclosed by the dotted lines in the figure. Specifically, terminal B0, delay element D0, terminal A0, multiplier c(0) and terminal E0 constitute a single circuit block, and B1, D1, A1, c(1) and E1 constitute a single circuit block. Similarly, a combination of BN-1, DN-1, AN-1, c(N-1) and EN-1 is assumed to be a circuit block. In other words, FIR filter 100 has N circuit blocks.

Adding section 106 has N adders, K0 to KN-1, and each adder adds maximum N input signals. Connecting section 107 has connectors S0 to SN-1 corresponding adders K0 to KN-1, and selects a signal to output from signals input from adders K0 to KN-1.

Bandwidth detecting section 108 detects a bandwidth of an input signal. The bandwidth of an input signal corresponds to the symbol rate, while corresponding to the oversampling number. For example, when an input signal is wide in bandwidth, the symbol rate is fast, and performing oversampling on a signal of fast symbol rate in constant sampling frequency obtains a small number of samplings. On the contrary, when an input signal is narrow in bandwidth, the symbol rate is low, and the number of samplings is large. Bandwidth detecting section 108 outputs a detection result to wiring control section 109.

Based on the relationship between a bandwidth of the input signal detected in bandwidth detecting section 108 and operable frequency of FIR filter 100, wiring control section 109 controls so that FIR filter 100 has a suitable filter structure. In other words, wiring control section 109 controls wiring between first wiring variable port 101 and second wiring variable port 103, wiring between third wiring variable port 105 and adding section 106, and operation of connecting section 109.

In this way, FIR filter 100 enables a cascade or parallel filter structure and further enables the number of parallels to be variable corresponding to the bandwidth of an input signal. As a result, it is possible to reconstruct the filter arbitrary while reducing the circuit size, without increasing in number multipliers, delay elements and adders.

The operation of FIR filter 100 with the above-mentioned configuration will be described below. The dotted lines in FIG. 4 indicate an example of case where wiring enabling its variations (variable wiring) is connected, and indicates a cascade filter structure. The operation in such a filter structure will be described below.

An input signal is input to terminal A0 of first wiring variable port 101 and bandwidth detecting section 108. Bandwidth detecting section 108 detects a bandwidth of the input signal, and outputs a detection result to wiring control section 109.

Based on the relationship between the bandwidth of the input signal detected in bandwidth detecting section 108 and operable frequency of FIR filter 100, wiring control section 109 controls connection between first wiring variable port 101 and second wiring variable port 103, connection between third wiring variable port 105 and adding section 106, and connectors of connecting section 107. In this case, the control is performed to obtain a cascade filter structure.

The signal input to the first wiring variable port is output to delay element D0 and multiplier c(0) via terminal A0. Delay element D0 delays the input signal by a sampling interval, and outputs the delayed signal to second wiring variable port 103.

The connection relationship between first wiring variable port 101 and second wiring variable port 103 is controlled by wiring control section 106, and as shown by the dotted line in FIG. 4, first wiring variable port 101 is connected to second wiring variable port 103. In this way, an output signal of terminal B0 is input to terminal A1, an output signal of terminal B1 is input terminal A2, and so on, an output signal of terminal BN-2 is input to terminal AN-1.

The signal input to terminal A0 of first wiring variable port 101 is output to multiplying section 104 via terminals A1 to AN-1, while being delayed in delay elements D0 to DN-2, respectively.

Multiplying section 104 multiplies signals output from first wiring variable port 101 by tap coefficients for which multipliers c(0) to c(N-1) are set, respectively. Specifically, multiplier c(0) multiplies a signal output from terminal A0 of first wiring variable port 101 by its tap coefficient, multiplier c(1) multiplies a signal output from terminal A1 of first wiring variable port 101 by its tap coefficient, and so on, multiplier c(N-1) multiplies a signal output from terminal AN-1 of first wiring variable port 101 by its tap coefficient. Thus, among tap coefficients of N taps prepared to implement filter frequency characteristics, one of the tap coefficients is multiplied by a signal output from each of terminals A0 to AN-1.

In addition, when it is desired to maintain filter frequency characteristics after the symbol rate is varied, the coefficient of each of multipliers c(0) to c(N-1) is kept at a fixed value.

Further, when making filter frequency characteristics variable, tap coefficients of multiplying section 104 may be made variable.

The multiplication results in multiplying section 104 are output to third wiring variable port 105. Specifically, a multiplication result in multiplier c(0) is output to terminal E0, a multiplication result in multiplier c(1) is output to terminal E1, and so on, a multiplication result in multiplier c(N-1) is output to terminal EN-1.

The connection relationship between third wiring variable port 105 and adding section 106 is controlled by wiring control section 106, and is as shown by the dotted lines in FIG. 4. In other words, all the signals output from terminals E0 to EN-1 are input to adder K0 of adding section 106, which adds the input signals. Herein, the case is explained where the number of multiplexing is 1 i.e. multiplexing is not performed.

Since FIR filter 100 has a cascade connection, connecting section 107 is controlled by wiring control section 109, and to output an addition result of adder k0 from FIR filter 100, only switch S0 is connected, while switches S1 to SN-1 are not connected.

The following is given of wiring control in wiring control section 109 i.e. filter structure based on the relationship between the bandwidth of an input signal and operable frequency of the filter. It is herein assumed that the oversampling number required for sections subsequent to the filter is 16-times.

When the bandwidth of an input signal is sufficiently smaller than the operable frequency of the filter, wiring control section 109 controls the variable wiring so as to obtain a cascade filter structure as described above.

When the bandwidth of an input signal increases and the filter can support only up to 8-times oversampling, the section 109 controls so as to obtain a two-parallel filter structure. When the bandwidth of an input signal further increases and the filter can support only up to 4-times oversampling, the section 109 controls so as to obtain a four-parallel filter structure. When the bandwidth of an input signal is larger than an operable frequency of the filter and the filter can support only up to 2-times oversampling, the section 109 controls so as to obtain an eight-parallel filter structure.

In this way, even when the bandwidth of an input signal increases and includes high-frequency components, it is possible to process the input signal in parallel by implementing a parallel filter structure, whereby it is possible to respond to the operable frequency of the filter even when the bandwidth of an input signal increases.

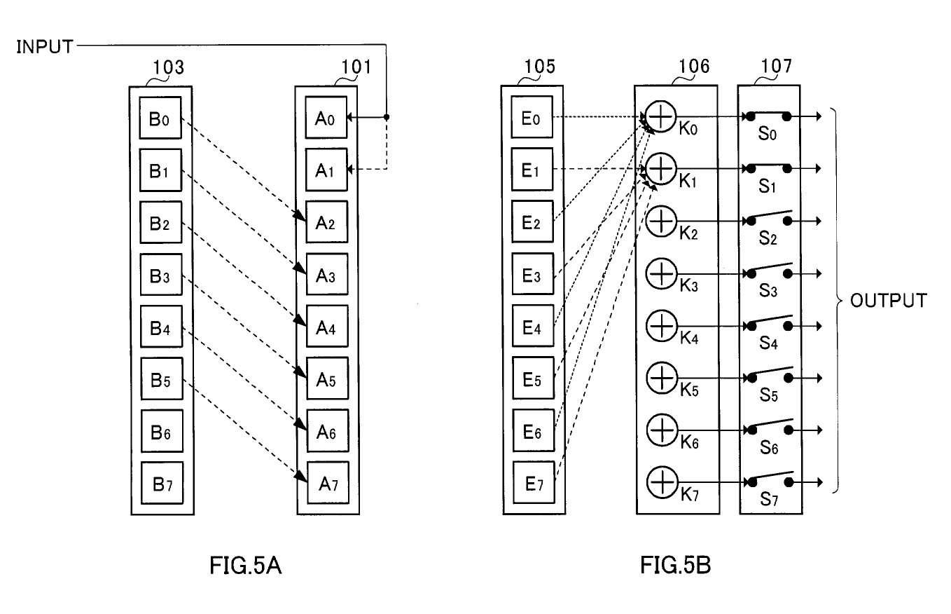

The following is given of the wiring of FIR filter 100 with a two-parallel filter structure. FIGS. 5A and 5B are views illustrating a two-parallel filter structure. Herein, the case is explained where the number N of taps is eight.

FIG. 5A illustrates wiring between first wiring variable port 101 and second wiring variable port 103. FIG. 5B illustrates wiring between third wiring variable port 105 and adding section 106, and connection of connecting section 107.

As shown in FIG. 5A, an input signal is input to terminals A0 and A1 of first wiring variable port 101. In second wiring variable port 103, an output signal of terminal B0 is input to terminal A2 of first wiring variable port 101, an output signal of terminal B1 is input to terminal A3, and so on, an output signal of terminal B5 is input to terminal A7.

As shown in FIG. 5B, output signals of terminals E0, E2, E4 and E6 of third wiring variable port 105 are input to terminal K0 of adding section 106. Output signals of terminals E1, E3, E5 and E7 are input to adder K1 of adding section 106.

Connecting section 107 makes S0 and S1 to output addition results of adders K0 and K1. Meanwhile, S2 to S7 do not output addition results, and therefore, remain unmade.

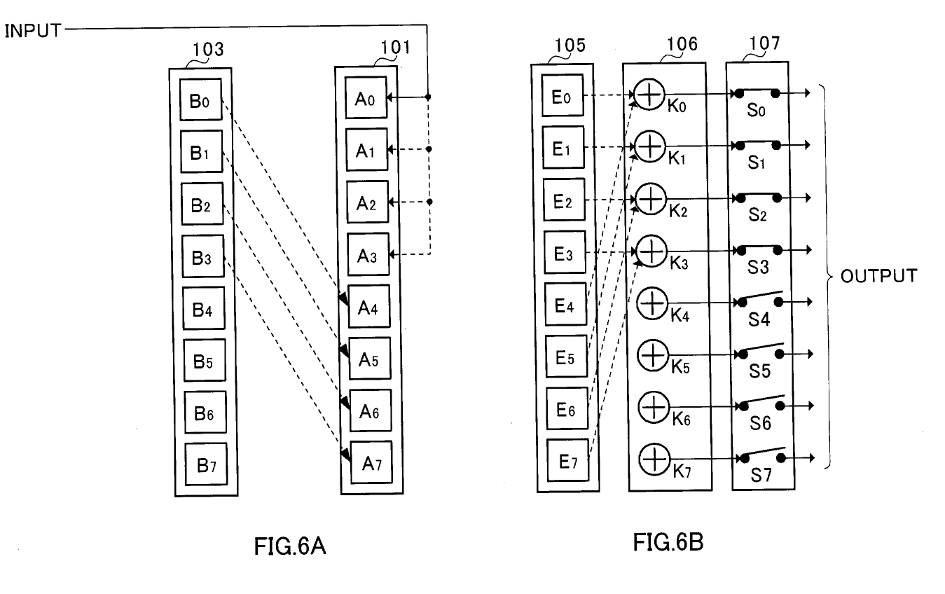

The following is given of the wiring of FIR filter 100 with a four-parallel filter structure. FIGS. 6A and 6B are views illustrating a four-parallel filter structure. Herein, the case is explained where the number N of taps is eight.

FIG. 6A illustrates wiring between first wiring variable port 101 and second wiring variable port 103. FIG. 6B illustrates wiring between third wiring variable port 105 and adding section 106, and connection of connecting section 107.

As shown in FIG. 6A, an input signal is input to terminals A0 to A3 of first wiring variable port 101. In second wiring variable port 103, an output signal of terminal B0 is input to terminal A4 of first wiring variable port 101, an output signal of terminal B1 is input to terminal A5, and so on, an output signal of terminal B3 is input to terminal A7. Terminals B4 to B7 of second wiring variable port 103 are not wired to first wiring variable port 101.

As shown in FIG. 6B, output signals of terminals E0 and E4 are input to adder K0 of adding section 106, while output signals of terminals E1 and E5 are input to adder K1. Output signals of terminals E2 and E6 are input to adder K2, while output signals of terminals E3 and E7 are input to adder K3.

Connecting section 107 makes S0 to S3 to output addition results of adders K0 to K3. Meanwhile, S4 to S7 do not output addition results, and therefore, remain unmade.

In this way, since FIR filter 100 outputs either parallel signals of a plurality of sequences or a single signal sequence, the operation speed required for FIR filter 100 is of predetermined sampling frequency, and it is possible to execute filtering processing on signals of high symbol rate.

In addition, first wiring variable port 101, second wiring variable port 103 and third wiring variable port 105 are each provided with N terminals, but are not limited to such a configuration, as long as it is possible to dynamically vary connection of delay elements and adders (connection between the delay elements) and the connection between multipliers and adders corresponding to control of wiring control section 109. Further, in terms of unit circuit block, it is only required to dynamically vary an input and output to/from the circuit block corresponding to the control of wiring control section 109.

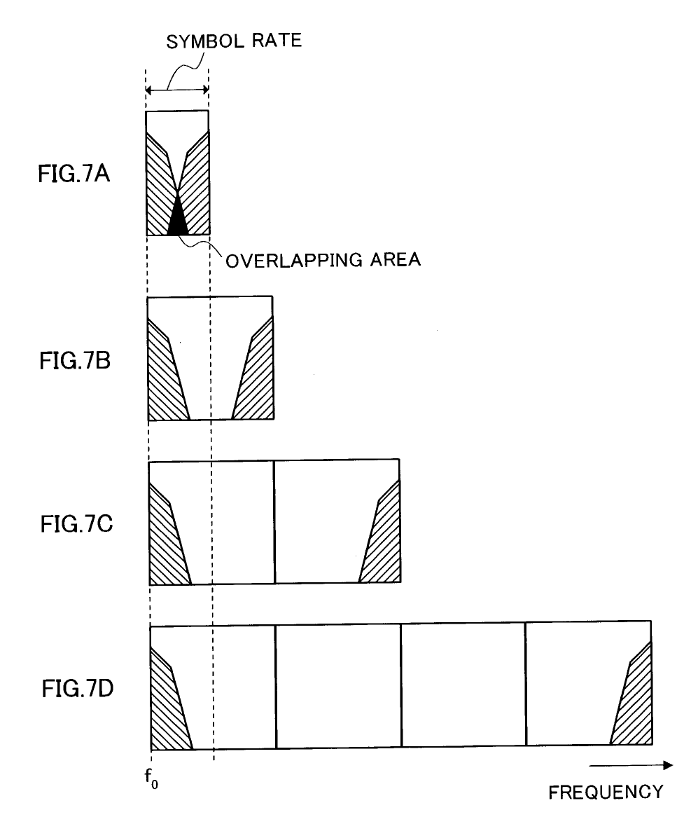

The oversampling number and aliasing will be described below. FIGS. 7A to 7D are views illustrating the relationship between the oversampling number and aliasing. In FIGS. 7A to 7D, shaded areas indicate frequency components of signals subjected to filtering processing, where the horizontal axis indicates frequency, while the vertical axis indicates signal intensity. In each figure, desired frequency components are as shown by the shaded areas around frequency F0 as the center. It is herein assumed that the pass-band region of the filter is a frequency bandwidth within twice the symbol rate around frequency F0 as the center. It is because of consideration that for example, in the case where a route roll-off filter and roll-off filter are used as a band-limitation filter, an input signal is limited to a frequency bandwidth twice the symbol rate when the roll-off coefficient a is 1.0 that is the maximum.

FIG. 7A illustrates a case of 1-time oversampling i.e. of sampling in a frequency of symbol rate. In this case, since the nyquist theorem is not satisfied, an overlapping area occurs where the desired frequency component and alias component overlap to one another. Further, the pass-band region includes the alias component. Therefore, the desired signal remarkably deteriorates due to the alias component, and when FIR filter 100 is applied to a communication reception apparatus, the reception performance deteriorates. Hence, in the present invention, 1-time oversampling is not performed.

FIG. 7B indicates discrete signals subjected to 2-times oversampling, FIG. 7C indicates discrete signals subjected to 4-times oversampling, and FIG. 7D indicates discrete signals 8-times oversampling. In FIGS. 7B to 7D, since an input signal is subjected to 2-times oversampling or more and results in discrete signals, the nyquist theorem is satisfied. Therefore, the desired signal component and alias component do not overlap to one another, and the possibility is low that the pass-band region includes an alias component. In other words, it is possible to avoid deterioration in desired signals due to aliasing, and when FIR filter 100 is applied to a communication reception apparatus, it is possible to avoid deterioration in reception performance due to aliasing.

In addition, FIR filter 100 is capable of executing parallel processing with a number of parallels half the tap number N at the maximum. Therefore, as illustrated in FIGS. 7B to 7D, even when oversampling numbers are different between input signals, by executing parallel processing corresponding to the oversampling number, it is possible to obtain processing precision equal to the case of sampling at the same oversampling number.

When it is assumed that P is a discrete number of an input signal of an FIR filter, R is a discrete number of an output signal, N is the number of taps, and M is the number of parallel processing lines, the following equation is obtained:

1≦R/P=M≦N/2

According to the above equation, wiring control section 109 controls first wiring variable port 101, second wiring variable port 103, third wiring variable port 105, adding section 106 and connecting section 107. In addition, P, R, M and N are natural numbers. Further, based on the bandwidth of an input signal detected in bandwidth detecting section 108, wiring control section 109 calculates discrete number P of the input signal i.e. oversampling number.

When the bandwidth of a discrete input signal increases by L times (L is a natural number), it may be possible that wiring control section 109 increases the number of parallels in a filter structure by L times, while decreasing the number of parallels in a filter structure by 1/L times when the bandwidth decreases by 1/L times. It is thereby possible to implement filter structures corresponding to frequency bandwidths i.e. symbol rates, and it is thus possible to execute filtering processing using the operable frequency of the filter.

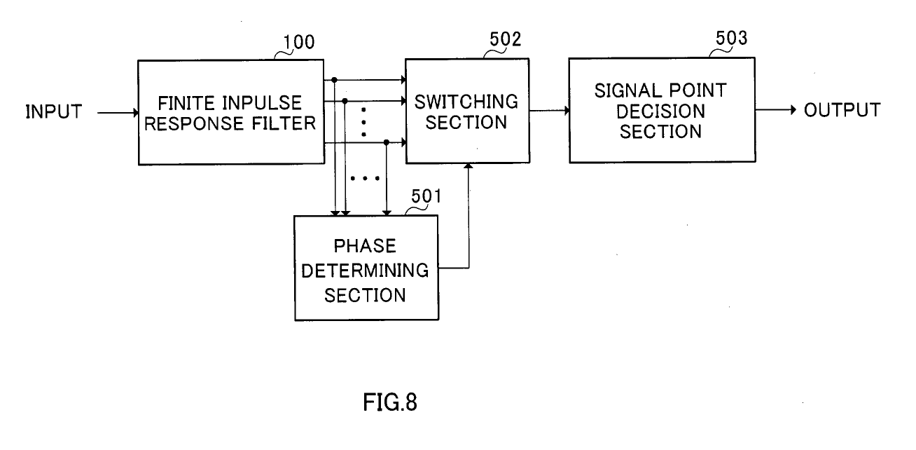

The case will be described below where FIR filter 100 according to the first embodiment is applied to a reception apparatus in a communication system. When there is no inter symbol interference, the reception apparatus is capable of making a signal decision from a signal of phase with the highest accuracy among oversampled phases, and therefore, is allowed to have a configuration as illustrated in FIG. 8. FIG. 8 is a block diagram illustrating a configuration of a communication reception apparatus according to the first embodiment of the present invention.

In FIG. 8, FIR filter 100 receives as its inputs discrete signals subjected to oversampling in a predetermined sampling frequency. The wiring is varied corresponding to the bandwidth as described above, and the input signal under goes the filtering processing. The filtering-processed signal is output to phase determining section 501 and switching section 502.

Based on signals output from FIR filter 100, phase determining section 501 determines a phase with the highest accuracy as a phase to be subjected to signal decision. The determined result is output to switching section 502.

Switching section 502 performs switching so as to output a signal including the phase with the highest accuracy determined in phase determining section 501 among signals output from FIR filter 100 to signal point decision section 503.

Signal point decision section 503 makes a signal point decision on the signal output from switching section 502 in the phase with the highest accuracy, and generates bit data. The generated bit data is output from signal point decision section 503.

In addition, it is equivalent to selecting signals at intervals such that the highest phase is obtained in the case of using a conventional FIR filter that phase determining section 501 determines a phase with the highest accuracy from signals output in parallel from FIR filter 100 to select.

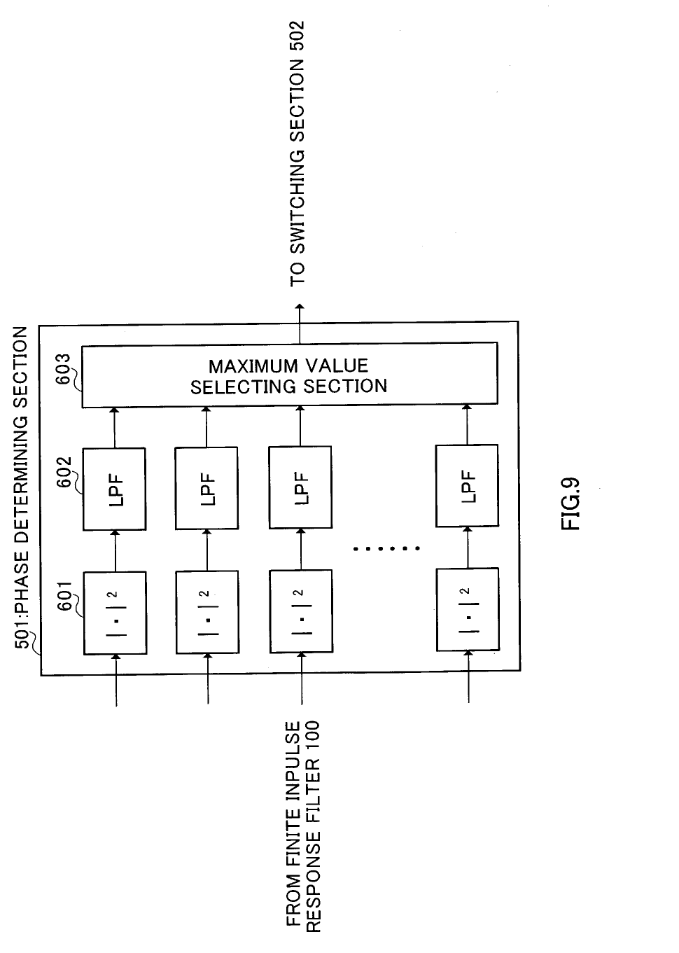

Phase determining section 501 will be described. FIG. 9 is a block diagram illustrating an internal configuration of phase determining section 501 in the first embodiment of the present invention. In FIG. 9, square section 601 squares a signal output from FIR filter 100, so as to make all the components positive. The calculation result is output to Low Pass Filter (LPF) 602.

LPF 602 eliminates the high-frequency components of the signal output from square section 601, and outputs only the signals of predetermined frequency components to maximum value selecting section 603.

Maximum value selecting section 603 selects a signal including the maximum value from among signals output from LPF 602. The selected signal indicates a signal of phase with the highest accuracy, and using the signal of this phase, signal point decision section 503 is capable of making a signal point decision accurately. Maximum value selecting section 603 outputs a selection result to switching section 502.

By thus applying FIR filter 100 to a communication reception apparatus, even when the bandwidth of an input signal is varied, the operation speed required for the filter is equal to the predetermined sampling frequency, and can be suppressed within limitations of filter processing speed.

In this way, according to this embodiment, the FIR filter is capable of having filter structures such as a cascade structure, two-parallel structure, four-parallel structure, eight-parallel structure, etc, by dynamically varying the wiring connecting predetermined numbers of delay elements, multipliers and adders prepared in advance corresponding to the bandwidth of an input signal. Therefore, it is possible to reduce the circuit size of the FIR filter, while responding to the oversampling number dynamically varied.

In addition, while this embodiment explains a cascade structure, two-parallel structure, four-parallel structure, and eight-parallel structure as available filter structures, the present invention is not limited to the foregoing, and enables a 2ⁿ-parallel structure. It is thereby possible to implement filter structures corresponding to frequency bandwidths in response to input signals subjected to 2ⁿ-oversampling.

Further, this embodiment explains that bandwidth detecting section 108 detects the bandwidth of an input signal, but it may be possible to separately use a signal indicative of the bandwidth of an input signal. For example, in communication systems, the transmitting side transmits information indicative of the bandwidth to use, and the receiving side obtains the bandwidth information from a demodulation section provided downstream from FIR filter 100 of the present invention.

Furthermore, in the case where the transmitting side does not transmit the bandwidth information, it may be possible that the variance is calculated based on signals detected downstream from FIR filter 100 of the present invention to judge whether the filter structure is proper, the bandwidth is determined based on the judgment result, and when the filter structure is proper, the structure is not varied, while being varied when the structure is not proper. Moreover, it may be possible to detect the bandwidth from a signal prior to the sampling.

(Second Embodiment)

While the first embodiment explains a direct FIR filter, the second embodiment of the present invention explains a transposed FIR filter.

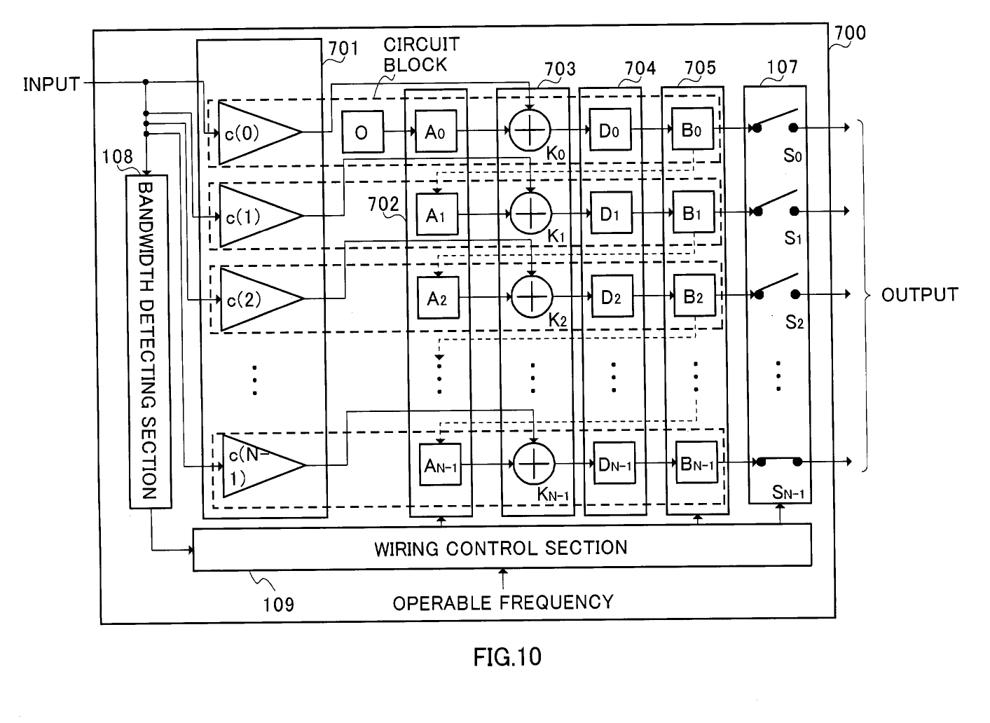

FIG. 10 is a block diagram illustrating a structure of FIR filter 700 according to the second embodiment of the present invention. In addition, in FIG. 10 sections common to FIG. 4 are assigned the same reference numerals as in FIG. 4, and specific descriptions thereof are omitted.

In FIG. 10, multiplying section 701 has N multipliers, c(0) to c(N-1), in advance set for respective tap coefficients, and multiplies input signal by the tap coefficients. The multiplication results are output to adding section 703.

First wiring variable port 702 has N terminals, A0 to AN-1, enabling variable wiring. Adding section 703 has N adders, K0 to KN-1, and the adders in the section 703 are connected to respective multipliers c(0) to c(N-1) and receive as their inputs signals output from the respective multipliers. The adders are further connected to terminals A0 to AN-1 of first wiring variable port 702, and receive as their inputs signals output from the terminals, respectively. Each of the adders adds the signal input from the multipliers and the signal input from the terminal, and outputs an addition result to delay section 704.

Delay section 704 has delay elements D0 to DN-1 with a delay time that is a sampling period. Delay elements D0 to DN-1 are provided corresponding to adders K0 to KN-1 respectively. Each of the delay elements delays a signal output from the adder, and outputs the delay signal to second wiring variable port 705. Second wiring variable port 705 has N terminals, B0 to BN-1, enabling variable wiring.

In this way, FIR filter 700 is capable of varying a filter structure to a cascade structure or parallel structure, and further making the number of parallels variable, corresponding to the bandwidth of an input signal. As a result, it is possible to reconstruct the filter arbitrary while reducing the circuit size, without increasing in number multipliers, delay elements and adders.

In addition, combinations of multipliers, adders and delay elements are assumed to be circuit blocks and enclosed by the dotted lines in the figure. Specifically, multiplier c(0), terminal A0, adder K0, delay element D0, and terminal B0 constitute a single circuit block, and c(1), A1, K1, D1 and B1 constitute a single circuit block. Similarly, a combination of c(N-1), AN-1, KN-1, DN-1, and BN-1 is assumed to be a single circuit block. In other words, FIR filter 700 has N circuit blocks.

The operation of FIR filter 700 with the above-mentioned configuration will be described below. The dotted lines in FIG. 10 indicate an example of case where variable wiring is connected, and indicates a cascade filter structure. The operation in such a filter structure will be described below.

An input signal is input to multiplying section 701 and bandwidth detecting section 108. Bandwidth detecting section 108 detects a bandwidth of the input signal, and outputs a detection result to wiring control section 109.

Based on the relationship between the bandwidth of the input signal detected in bandwidth detecting section 108 and operable frequency of FIR filter 700, wiring control section 109 controls connection between first wiring variable port 702 and second wiring variable port 705. The section 109 further controls connectors of connecting section 107. In this case, the control is performed to obtain a cascade filter structure.

Terminal A0 of first wiring variable port 702 does not need an input of a signal, and therefore, receives 0 as its input.

Multiplying section 701 multiplies input signals by tap coefficients for which multipliers c(0) to c(N-1) are set, respectively. The multiplication result of each of the multipliers is output to adding section 703.

Adding section 703 receives as its inputs signals output from multiplying section 701 and first wiring variable port 702. Specifically, signals output from multiplier c(0) and terminal A0 of first wiring variable port 702 are input to adder K0, signals output from multiplier c(1) and terminal A1 are input to adder K1, and so on, signals output from multiplier c(N-1) and terminal AN-1 are input to adder KN-1. Adders K0 to KN-1 add input signals, and output addition results to delay section 704.

In delay section 704, signals output from adders K0 to KN-1 are input to delay elements D0 to DN-1, respectively. Specifically, a signal output from adder K0 is input to delay element D0, a signal output from adder K1 is input to delay element D1, and so on, a signal output from adder KN-1 is input to delay element DN-1. The signal input to each of delay elements D0 to DN-1 is delayed by a sampling period. The delayed signals are output to second wiring variable port 705.

Second wiring variable port 705 receives as its inputs signals output from delay section 704. Specifically, a signal output from delay element D0 is input to terminal B0, and a signal output from delay element D1 is input to terminal BE1, and so on, a signal output from delay element DN-1 is input to terminal BN-1.

The connection relationship between second wiring variable port 705 and first wiring variable port 702 is controlled by wiring control section 109, and a signal input to second wiring variable port 705 is output to first wiring variable port 702 and connecting section 107. Specifically, a signal output from terminal B0 is input to terminal A1 and connector S0, a signal output from terminal B1 is input to terminal A2 and connector S1, and so on, a signal output from terminal BN-2 is input to terminal AN-1 and connector SN-2. Further, terminal BN-1 outputs a signal output from delay element DN-1 to connector SN-1.

Since FIR filter 700 has a cascade connection, connecting section 107 is controlled by wiring control section 109, and only connector SN-1 is connected, while connectors S0 to SN-2 are not connected.

The following is given of wiring control in wiring control section 109 i.e. filter structure based on the relationship between the bandwidth of an input signal and operable frequency of the device. It is herein assumed that the oversampling number required for sections subsequent to the filter is 16-times.

When the bandwidth of an input signal is sufficiently smaller than the operable frequency of the filter, wiring control section 109 controls the wiring so as to obtain a cascade filter structure as described above.

When the bandwidth of an input signal increases and the filter can support only up to 8-times oversampling, the section 109 controls so as to obtain a two-parallel filter structure. When the bandwidth of an input signal further increases and the filter can support only up to 4-times oversampling, the section 109 controls so as to obtain a four-parallel filter structure. When the bandwidth of an input signal is larger than an operable frequency of the filter and the filter can support only up to 2-times oversampling, the section 109 controls so as to obtain an eight-parallel filter structure.

In this way, even when the bandwidth of an input signal increases and includes high-frequency components, it is possible to process the input signal in parallel by implementing a parallel filter structure, whereby it is possible to respond to the operable frequency of the filter even when the bandwidth of an input signal increases.

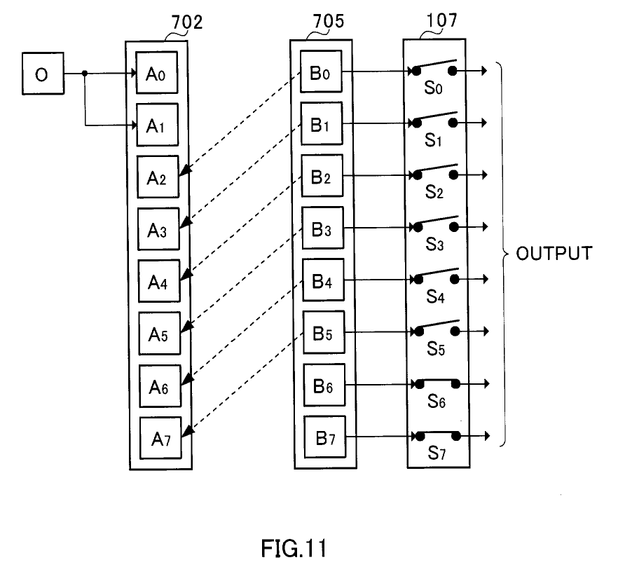

The following is given of the wiring of FIR filter 700 with a two-parallel filter structure. FIG. 11 illustrates wiring between first wiring variable port 702 and second wiring variable port 705, and connection of connecting section 107. Herein, the case is explained where the number N of taps is eight.

As shown in FIG. 11, 0 is input to terminals A0 and A1 of first wiring variable port 702. A signal output from terminal B0 is input to terminal A2 and connector S0, a signal output from terminal B1 is input to terminal A3 and connector S1, and so on, a signal output from terminal B5 is input to terminal A7 and connector S5.

Connectors S0 to S5 remain unmade, and connector S6 or S7 is made to output two-parallel signals.

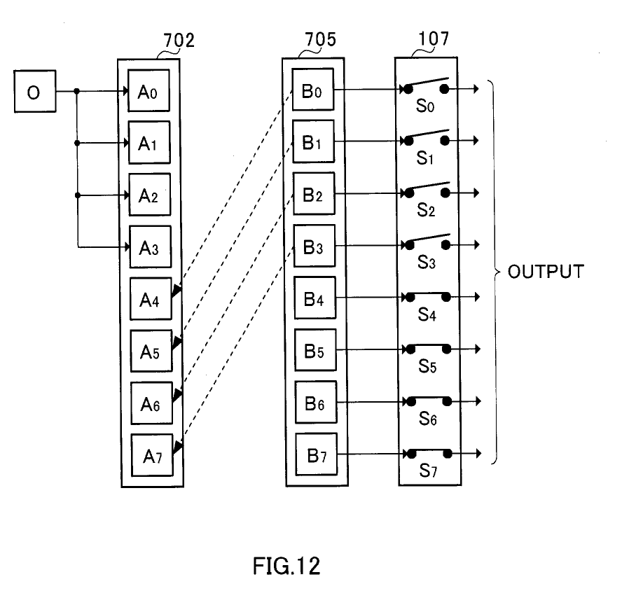

The following is given of the wiring of FIR filter 700 with a four-parallel filter structure. FIG. 12 illustrates wiring between first wiring variable port 702 and second wiring variable port 705, and connection of connecting section 107. Herein, the case is explained where the number N of taps is eight.

As shown in FIG. 12, 0 is input to terminals A0 to A3 of first wiring variable port 702. A signal output from B0 is input to terminal A4 and connector S0, a signal output from terminal B1 is input to terminal A5 and connector S1, and so on, a signal output from terminal B3 is input to terminal A7 and connector S3.

Further, connectors S0 to S3 remain unmade, and connectors S4 to S7 are made to output four-parallel signals.

Thus, according to this embodiment, in a transposed FIR filter, it is possible to provide the FIR filter with filter structures such as a cascade structure, two-parallel structure, four-parallel structure, eight-parallel structure, etc, by dynamically varying the wiring connecting predetermined numbers of delay elements, multipliers and adders prepared in advance corresponding to the bandwidth of an input signal. Therefore, it is possible to reduce the circuit size of the FIR filter, while responding to the oversampling number dynamically varied.

In addition, first wiring variable port 702 and second wiring variable port 705 are each provided with N terminals, but are not limited to such a configuration, as long as it is possible to dynamically vary connection of delay elements and adders corresponding to the control of wiring control section 109. In other words, in terms of unit circuit block, it is only required to dynamically vary the wiring of the delay element and an adder of another circuit block corresponding to the control of wiring control section 109.

Further, this embodiment explains that bandwidth detecting section 108 detects the bandwidth of an input signal, but it may be possible to separately use a signal indicative of the bandwidth of an input signal. For example, in communication systems, the transmitting side transmits information indicative of the bandwidth to use, and the receiving side obtains the bandwidth information from a demodulation section provided downstream from FIR filter 700 of the present invention.

Furthermore, in the case where the transmitting side does not transmit the bandwidth information, it may be possible that the variance is calculated based on signals detected downstream from FIR filter 700 of the present invention to judge whether the filter structure is proper, the bandwidth is determined based on the judgment result, and when the filter structure is proper, the structure is not varied, while being varied when the structure is not proper. Moreover, it may be possible to detect the bandwidth from a signal prior to the sampling.

(Third Embodiment)

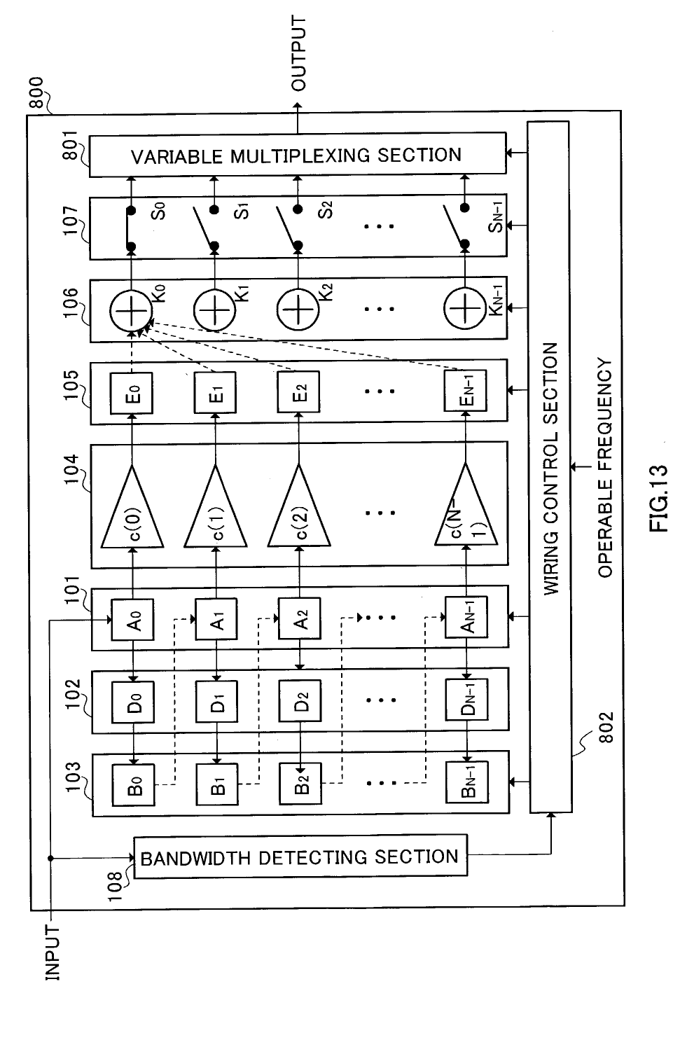

FIG. 13 is a block diagram illustrating a structure of FIR filter 800 according to the third embodiment of the present invention. In addition, in FIG. 13 sections common to FIG. 4 are assigned the same reference numerals as in FIG. 4, and specific descriptions thereof are omitted. FIG. 13 differs from FIG. 4 in the respect variable multiplexing section 801 is added and wiring control section 109 is modified to wiring control section 802.

Variable multiplexing section 801 multiplexes a plurality of signal lines output in parallel from connecting section 107 to a single signal line to output a multiplexed signal. In addition, a single signal line from connecting section 107 is output with the number of multiplexing is 1, i.e. without being multiplexed.

Wiring control section 802 controls variable multiplexing section 801, corresponding to the bandwidth of an input signal detected in bandwidth detecting section 108. For example, when connecting section 107 outputs two signal lines corresponding to the bandwidth of an input signal (see FIG. 5B), wiring control section 802 controls variable multiplexing section 801 so as to multiplex two signal lines to a single signal line. Further, when connecting section 107 outputs four signal lines corresponding to the bandwidth of an input signal (see FIG. 6B), wiring control section 802 controls variable multiplexing section 801 so as to multiplex four signal lines to a single signal line. In other words, variable multiplexing section 801 varies the number of multiplexing corresponding to the bandwidth of an input signal.

In this way, when signals output from the FIR filter are of a plurality of lines, the signal lines are multiplexed to a single signal line, thereby enabling a device that cannot process a plurality of signal lines to process signals. For example, conventional communication reception apparatuses that have been generally used are not provided with devices that respond to a plurality of lines of input signals like phase determining section 502 and switching section 503 illustrated in FIG. 8 in the first embodiment. Thus, it is not possible to apply FIR filters 100 and 700 without variable multiplexing section 801 to the conventional communication reception apparatuses. Therefore, by providing variable multiplexing section 801 as described above, it is possible to readily apply the FIR filter of this embodiment to the conventional communication reception apparatuses.

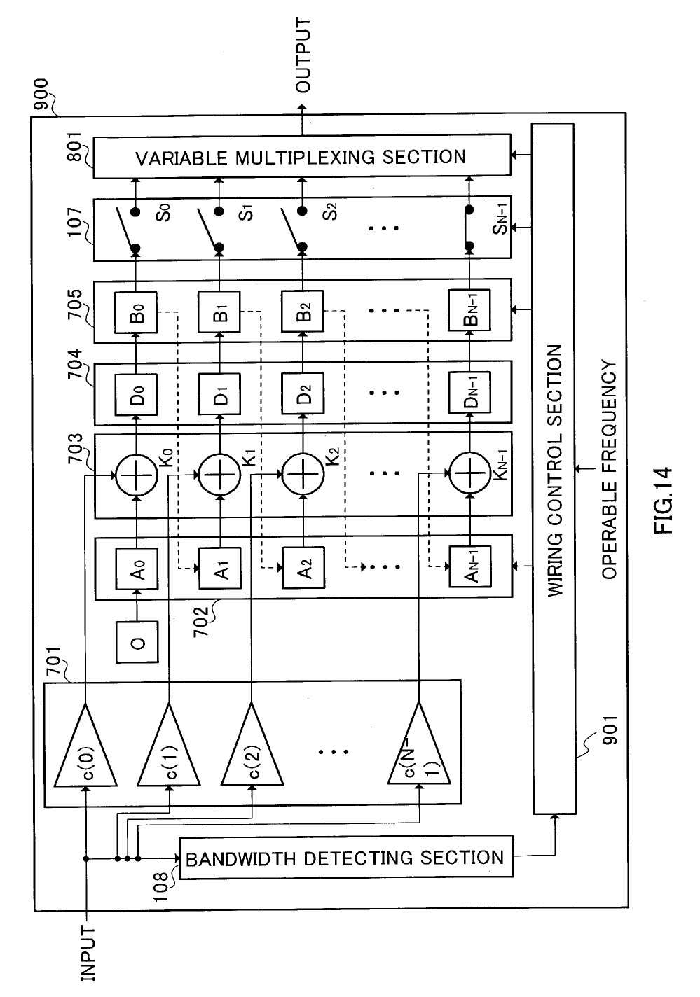

In addition, FIG. 14 illustrates a transposed FIR filter provided with variable multiplexing section 801 as described above. In other words, the structure as illustrated in FIG. 14 is the same as that in FIG. 10 except variable multiplexing section 801 and wiring control section 901. Variable multiplexing section 801 as illustrated in FIG. 14 also performs 2-times multiplexing when connecting section 107 outputs two signal lines as illustrated in FIG. 11. Further, the section 801 performs 4-times multiplexing when connecting section 107 outputs four signal lines as illustrated in FIG. 12.

Thus, according to this embodiment, the FIR filter has a variable multiplexing section that performs multiplexing using the number of multiplexing corresponding to the bandwidth of an input signal, whereby the FIR filter outputs a single multiplexed signal line, and it is thus possible to readily apply the FIR filter to conventional communication reception apparatuses.

(Fourth embodiment)

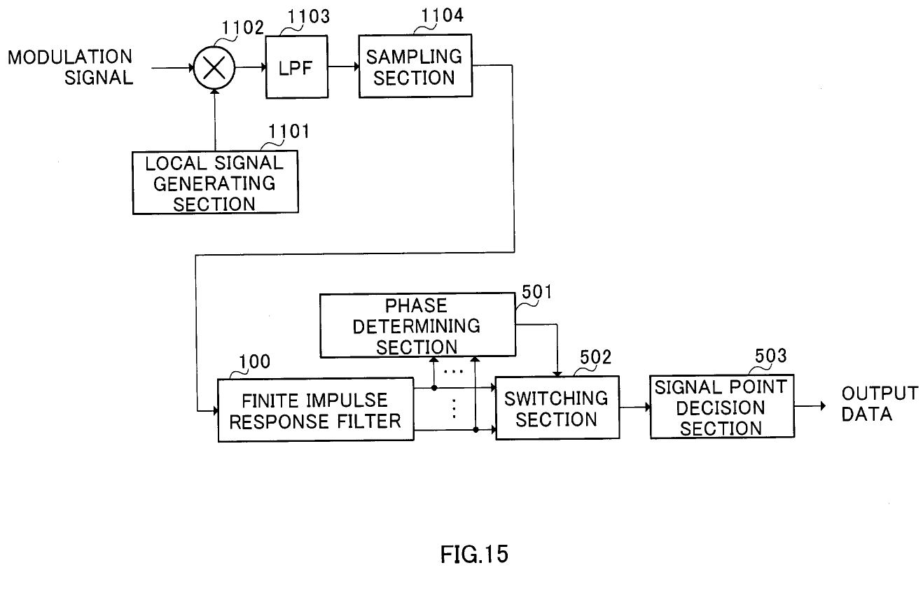

FIG. 15 is a block diagram illustrating a configuration of a communication reception apparatus according to the fourth embodiment of the present invention. In addition, in FIG. 15 sections common to FIG. 8 are assigned the same reference numerals as in FIG. 8, and specific descriptions thereof are omitted. Local signal generating section 1101 generates a local signal used in frequency conversion of modulation signal, and outputs the generated local signal to frequency conversion section 1102.

Frequency conversion section 1102 receives a modulation signal and multiplies the modulation signal by the local signal output from local signal generating section 1101. The frequency conversion is thus performed on the modulation signal to generate a baseband signal. The baseband signal is output to LPF 1103.

Among the baseband signal output from frequency conversion section 1102, LPF 1103 eliminates components in bands more than half the sampling frequency, and outputs only signals of predetermined frequency components to sampling section 1104. It is thereby possible to eliminate components in bands half the sampling frequency, for example, thermal noises and image frequency components generated by frequency conversion.

Sampling section 1104 performs sampling on signals output from LPF 1103 at intervals that are predetermined sampling periods to generate discrete signals. The discrete signals are output to FIR filter 100.

Thus, according to this embodiment, it is possible to apply FIR filter 100 explained in the first embodiment to a communication reception apparatus, and since the circuit size of FIR filter 100 is reduced, it is possible to reduce the apparatus size of the reception apparatus.

In addition, while in this embodiment frequency conversion is performed only prior to sampling section 1104, it may be possible that frequency conversion is performed subsequent to sampling section 1104, and a signal subjected to frequency conversion is input to FIR filter 100.

These FIR filters are capable of being applied to wireless LAN reception apparatuses.

(Fifth embodiment)

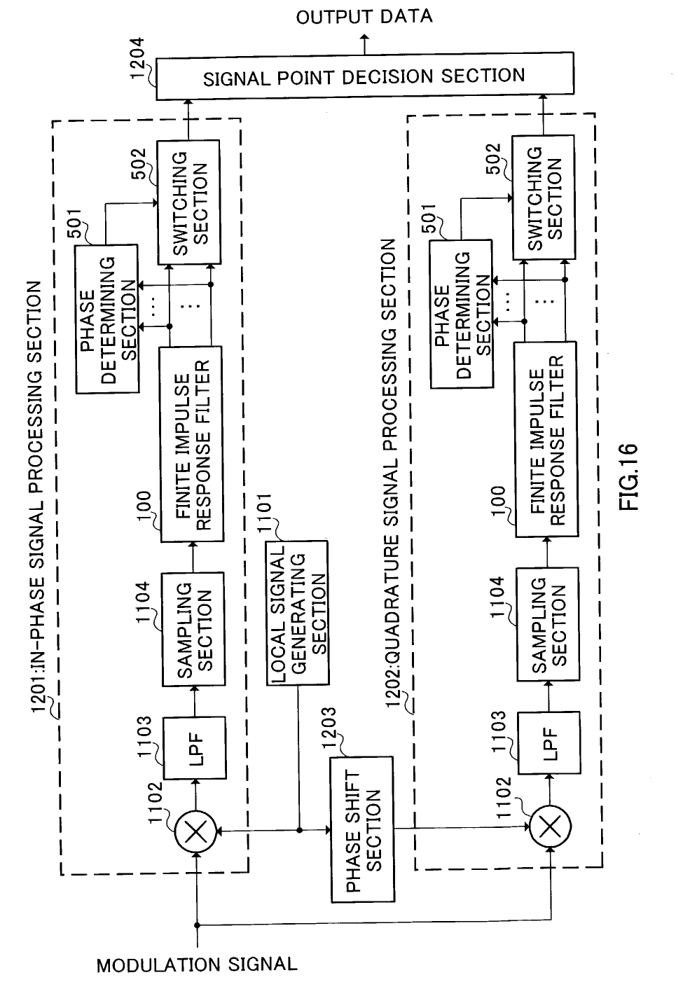

FIG. 16 is a block diagram illustrating a configuration of a quadrature signal reception apparatus according to the fifth embodiment of the present invention. In addition, in FIG. 16 sections common to FIG. 15 are assigned the same reference numerals as in FIG. 15, and specific descriptions thereof are omitted. In FIG. 16, I-signal (in-phase signal) processing section 1201 and Q-signal (quadrature signal) processing section 1202 are each provided with processing sections of from frequency conversion section 1102 to switching section 502 as illustrated in FIG. 15.

Local signal generating section 1101 generates a local signal used in frequency conversion of modulation signal, and outputs the generated local signal to Frequency conversion section 1102 in I-signal processing section 1201 and shift section 1203.

Phase shift section 1203 shifts a phase of the local signal output form local signal generating section 1101 by 90°. The local signal of 90°-shifted phase is output to frequency conversion section 1102 in Q-signal processing section 1202.

Frequency conversion section 1102 in I-signal processing section 1201 multiplies the modulation signal by the local signal, and thus performs frequency conversion on the modulation signal. Similarly, frequency conversion section 1102 in Q-signal processing section 1202 multiplies the modulation signal by the local signal of 90°-shifted phase, and thus performs frequency conversion on the modulation signal. Thus, the modulation signal undergoes quadrature demodulation, and is divided to I (in-phase) component and Q (quadrature) component of the baseband signal.

I-signal processing section 1201 and Q-signal processing section 1202 perform signal processing respectively on I component of the baseband signal and Q component of the baseband signal corresponding to the symbol rate. The processed signals are output to signal point decision section 1204.

Based on the I-signal output from I-signal processing section 1201 and Q-signal output from Q-signal processing section 1202, signal point decision section 1204 makes a signal decision to generate bit data. The generated bit data is output from signal point decision section 1204.

Thus, according to this embodiment, it is possible to apply FIR filter 100 explained in the first embodiment to a quadrature signal reception apparatus, and since the circuit size of FIR filter 100 is reduced, it is possible to reduce the apparatus size of the quadrature signal reception apparatus.

In addition, while in this embodiment quadrature demodulation is performed prior to sampling section 1104, it may be possible that quadrature demodulation is performed subsequent to sampling section 1104, and signals subjected to quadrature demodulation are input to FIR filter 100.

(Sixth embodiment)

The sixth embodiment describes the operation of FIR filter 100 when the symbol rate of a transmission signal is varied corresponding to communication propagation path conditions.

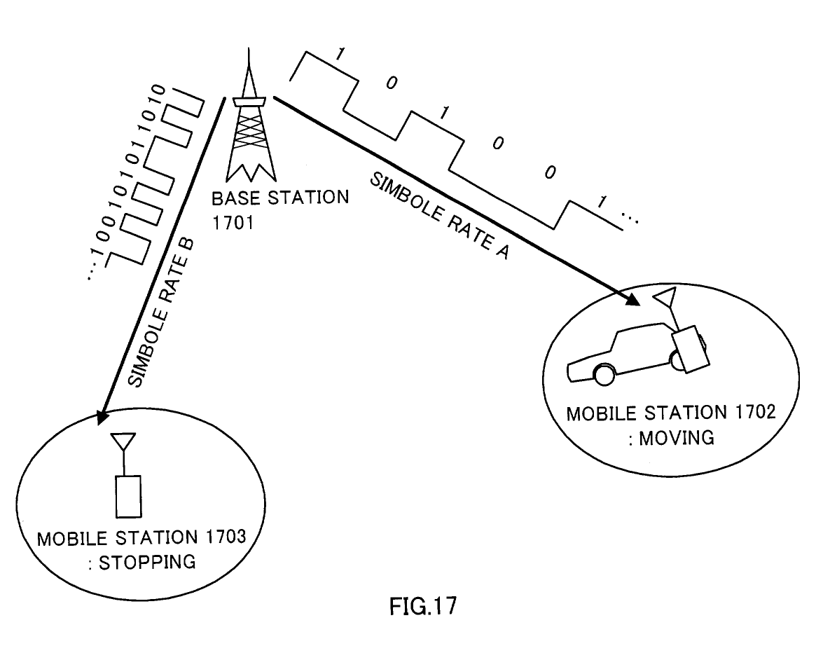

A mobile station that receives communication signals from a base station is expected to be used in moving by car or in stopping in a restaurant, etc. FIG. 17 is a conceptual view illustrating a base station transmitting signals to mobile stations at symbol rates corresponding to moving or stopping. As illustrated in FIG. 17, when mobile station 1702 is moving, since the communication propagation path conditions are poor, base station 1701 decreases symbol rate A to enhance the error resistance. When mobile station 1703 is stopping, since the communication propagation path conditions are good, base station 1701 eases the error resistance and increases symbol rate B. Thus, it is intended that base station 1701 dynamically varies the symbol rate to transmit signals.

Assuming that mobile stations 1702 and 1703 each have the communication reception apparatus as illustrated in FIG. 8, the operations of mobile stations 1702 and 1703 will be described again with reference to FIGS. 4 and 8. When the base station transmits signals whose symbol rate has been varied dynamically, mobile stations 1702 and 1703 detects the symbol rate of an input signal in bandwidth detecting section 108 of FIR filter 100. In addition, increasing the symbol rate widens the frequency bandwidth, while decreasing the symbol rate narrows the frequency bandwidth. In other words, it is required to vary the filter structure corresponding to variations in symbol rate. The detection result is output to wiring control section 109.

Based on the symbol rate of an input signal detected in bandwidth detecting section 108, wiring control section 109 controls the variable wiring and connecting section 107. For example, an eight-parallel filter structure is set when the symbol rate is high, and a four-parallel filter structure is set when the symbol rate is a little high. Further, a two-parallel filter structure is set when the symbol rate is a little low, and a cascade filter structure is set when the symbol rate is low.

Thus, according to this embodiment, when input signals are signals transmitted at the symbol rate varied corresponding to communication propagation path conditions, the communication reception apparatus of a mobile station constructs a filter corresponding to the symbol rate, and thereby is capable of receiving the signals with accuracy.

In addition, when the input signal includes a signal indicative of the symbol rate, it may be possible that bandwidth detecting section 108 detects the signal, and corresponding to variations in symbol rate, wiring control section 109 controls the variable wiring.

Further, while FIG. 17 assumes wireless propagation paths, a filter may be similarly constructed in wired communications with variable symbol rates. For example, the communication reception apparatus monitors communication quality, and constructs a filter corresponding to low symbol rate when the quality deteriorates, while constructing a filter corresponding to high symbol rate when the quality is improved.

(Seventh embodiment)

The seventh embodiment of the present invention describes a case where FIR filter 800 as illustrated in FIG. 13 in the third embodiment is applied to a communication reception apparatus.

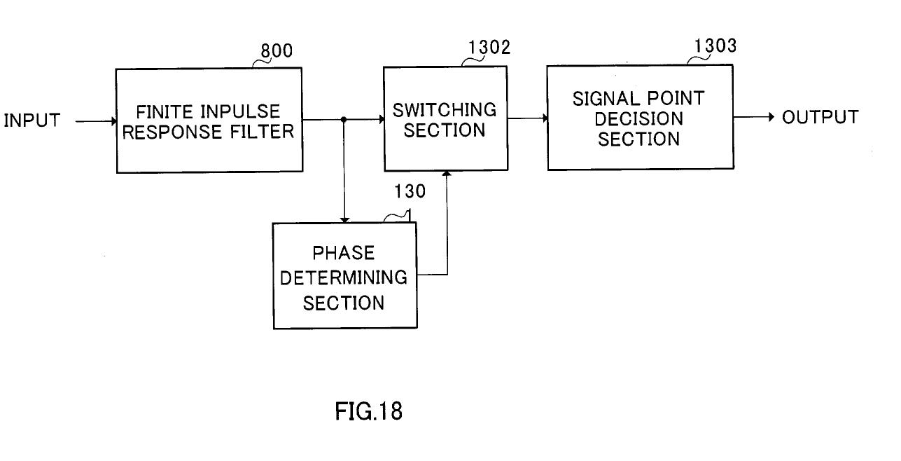

FIG. 18 is a block diagram illustrating a configuration of the communication reception apparatus according to the seventh embodiment of the present invention. In FIG. 18, based on signals output from FIR filter 800, phase determining section 1301 determines a phase with the highest accuracy as a phase for use in signal point decision. The determined result is output to switching section 1302.

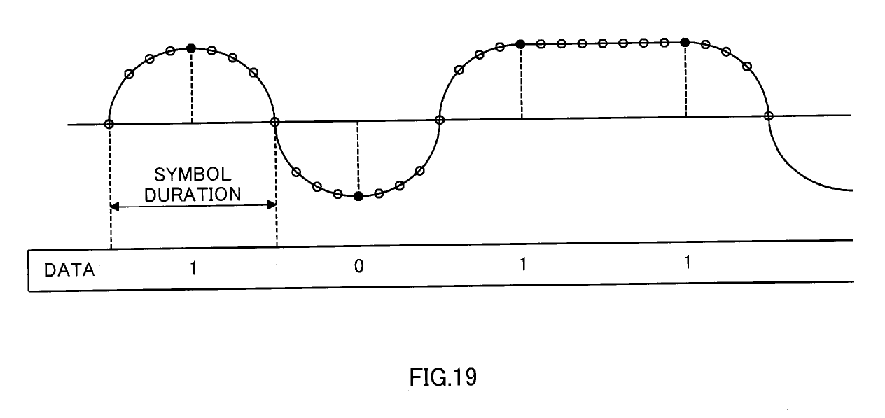

Among signals output from FIR filter 800, switching section 1302 outputs only signals of phase with the highest accuracy determined in phase determining section 1301 to signal point decision section 1302, which will be described with reference to FIG. 19.

FIG. 19 is a schematic view illustrating signals output from the switching section 1302 in the seventh embodiment of the present invention. In FIG. 19, black circles represent signals whose phase is determined in phase determining section 1301 to have the highest accuracy. White signals represent other discrete signals. Since signal point decision section 1303 requires only signals shown by the black circles, switching section 1302 outputs only the signals shown by the black circles to signal point decision section 1303.

Thus, according to this embodiment, the switching section selects only signals of desired phase among a plurality of signal lines output from the FIR filter, and it is thereby possible to reduce the processing subsequent to the switching section, while improving the precision.

In addition, while in this embodiment only a signal of some phase per symbol is output to the signal point decision section, the present invention is not limited to the foregoing. For example, when an adaptive equalizer is provided downstream of the switching section, the switching section may output two signals of different phases per symbol so as to enable excellent convergence in adaptive operation.

Further, while this embodiment explains the case of using FIR filter 800, FIR filter 900 may be used.

(Eighth embodiment)

The eighth embodiment of the present invention explains the case of tap coefficients of FIR filter 100 described in the first embodiment correspond to the impulse response of route nyquist filter.

The FIR filter according to this embodiment has tap coefficients corresponding to the impulse response of route nyquist filter. It is thereby possible to set optimal filter characteristics with respect to linear modulation schemes and partial response signals frequently used in wireless communications, etc. Further, it is possible to obtain excellent filter outputs with less delay distortion or the like.

In particular, when it is necessary to perform the band limitation on transmitting side as in wireless communications, it is preferable that the transmitting and receiving sides use a route nyquist filter because the total characteristics of the band-limitation filter are of the nyquist filter.

In addition, when the band limitation is not required as in wired communications, only the receiving side uses the nyquist filter, and it is thereby possible to reduce effects caused by thermal noises or the like.

(Ninth embodiment)

The ninth embodiment of the present invention explains the case where FIR filter 100 is achieved by using a Filed Programmable Gate Array (FPGA) that is an integrated circuit enabling reconstruction by rewriting the program.

FPGA is a device that dynamically varies the connection of wiring readily. FIR filter 100 achieved by the FPGA is flexible system and apparatus, while being capable of processing signals of high symbol rates.

In addition, among devices constituting FIR filter 100 of the present invention, it may be possible to use devices that cannot be reconstructed such as Application Specific Integrated Circuit (ASIC) for delay section 102, multiplying section 104 and adding section 106, while using FPGA only for variable wiring portion. Thus, it is possible to implement FIR filter 100 with high speed and low cost.

Further, it may be possible that a variable wiring portion has a plurality of wiring relations, and the wiring control section controls to use either wiring relation corresponding to variations in symbol rate.

Thus, according to this embodiment, by implementing the variable wiring portion of FIR filter 100 with FPGA, the filter has a plurality of wiring portions of small circuit size, instead of having a plurality of circuit blocks of large circuit size, thereby preventing increases in circuit size.

(Tenth embodiment)

The tenth embodiment of the present invention explains the case where FIR filter 100 is achieved by using a Digital Signal Processor (DSP) that is an integrated circuit enabling reconstruction by rewriting the program.

DSP is a device capable of varying a structure readily by program. FIR filter 100 achieved by the DSP is more flexible system and apparatus, and is capable of reducing the circuit size.

Delay section 102, multiplying section 104 and adding section 106 constituting FIR filter 100 of the present invention are each assumed to be a module. The program for operating DSP describes adaptively varying only the relationships between inputs and outputs of modules corresponding to variations in symbol rate, and it is thereby possible to decrease the program capacity.

(Eleventh embodiment)

The eleventh embodiment explains the case where FIR filter 100 is achieved by using a switched capacitor filter that switches a plurality of capacitors with different capacitances to vary tap coefficients and FPGA or DSP.

The FIR filter according to this embodiment implements delay elements, multipliers and adders by the switched capacitor filter, and receives discrete analog signals as input signals. In other words, the input signal is not sampled as in the A/D converter, and signals only subjected to discrete processing are input to the switched capacitor filter wired by FPGA or DSP.

In this way, it is possible to perform filtering processing on signals of high symbol rate at which the A/D converter cannot operation. Further, since only a variable wiring portion is implemented by FPGA or DSP, flexible communication apparatuses can be achieved.

(Twelfth embodiment)

The twelfth embodiment of the present invention explains a communication transmission apparatus, communication reception apparatus and software wireless apparatus each using FIR filter 100 of the present invention.

When FIR filter 100 of the present invention is applied to a communication transmission apparatus, since it is possible to flexibly construct a transmission filter requiring filter characteristics with high precision and with less modulation precision error, it is possible to improve the spectral efficiency.

When FIR filter 100 of the present invention is applied to a communication reception apparatus, since it is possible to flexibly construct a reception filter requiring filter characteristics with high precision and with flat group delay characteristics, it is possible to maintain the communication quality at high level.

When FIR filter 100 of the present invention is applied to a software wireless apparatus, since it is possible to flexibly construct a band-limitation filter that supports a plurality of communication systems and to respond to signals of high symbol rate, it is possible to provide flexible communication environments.

In addition, above-mentioned embodiments 4 to 6 and 8 to 12 explain the case of using FIR filter 100, but the present invention is not limited to such a case. Transposed FIR filter 700 is capable of being used.

A finite impulse response filter of a first aspect of the present invention is a finite impulse response filter that varies a frequency bandwidth corresponding to an input signal subjected to 2ⁿ-times (n is a positive number) oversampling, and has N circuit blocks each having a delay element that delays the input signal sequentially and a multiplier that multiplies a delayed input signal by a tap coefficient set in advance, an adding section that adds outputs from multipliers of the circuit blocks, a bandwidth detecting section that detects a frequency bandwidth from the input signal, and a wiring control section that dynamically controls connections of wiring of inputs and outputs of the N circuit blocks corresponding to the detected bandwidth.

According to this aspect, although the oversampling number is decreased and the processing precision of filter is decreased when the frequency bandwidth of an input signal is increased inconstant sampling frequency, since it is possible to vary connections of wiring of inputs and outputs of N circuit blocks corresponding to the bandwidth of an input signal, it is possible to implement a direct FIR filter with precision higher than that of actual oversampling number by constructing a filter with an increased number of parallels. Further, since the connection relationship between predetermined numbers of delay elements, multipliers and adders is only varied, it is possible to reduce the circuit size.

A finite impulse response filter of a second aspect of the present invention is a finite impulse response filter that varies a frequency bandwidth corresponding to an input signal subjected to 2ⁿ-times (n is a positive number) oversampling, and has N circuit blocks each having a multiplier that multiplies an input signal by a tap coefficient set in advance, an adder that receives as its input a multiplication result by the multiplier, and a delay element that delays an addition result by the adder, a bandwidth detecting section that detects a frequency bandwidth from the input signal, and a wiring control section that dynamically controls connections of wiring connecting the delay element and an adder of another circuit block corresponding to the detected bandwidth.

According to this aspect, although the oversampling number is decreased and the processing precision of filter is decreased when the frequency bandwidth of an input signal is increased in constant sampling frequency, since it is possible to vary connections of wiring connecting the delay element and an adder of another circuit block corresponding to the bandwidth of an input signal, it is possible to implement a transposed FIR filter with precision higher than that of actual oversampling number by constructing a filter with an increased number of parallels. Further, since the connection relationship between predetermined numbers of delay elements, multipliers and adders is only varied, it is possible to reduce the circuit size.

As described above, according to the present invention, the wiring connecting predetermined numbers of delay elements, multipliers and adders is made variable arbitrarily, and when the oversampling number of an input signal is dynamically varied, the wiring is varied so as to obtain a filter structure with a number of parallels corresponding to the oversampling number, whereby it is possible to respond to dynamically varied oversampling number and to reduce the circuit size. Further, it is possible to obtain the filtering processing precision equivalent to the case of performing oversampling in number the same as that of tap coefficients.

The present invention is not limited to the above described embodiments, and various variations and modifications may be possible without departing from the scope of the present invention.

This application is based on the Japanese Patent Application No. 2002-117269 filed on Apr. 19, 2002, entire content of which is expressly incorporated by reference herein.

What is claimed is:

1. A finite impulse response filter that varies a frequency bandwidth corresponding to an input signal subjected to 2ⁿ-times (n is a positive number) oversampling, comprising:
N circuit blocks each of which has a delay element that delays the input signal sequentially and a multiplier that multiplies a delayed input signal by a tap coefficient set in advance;
an adding section that adds outputs from multipliers of the circuit blocks;
a bandwidth detecting section that detects a frequency bandwidth from the input signal; and
a wiring control section that dynamically controls connections of wiring of inputs and outputs of the N circuit blocks corresponding to the detected bandwidth.

2. The finite impulse response filter according to claim 1, wherein each of the N circuit blocks further has a wiring variable port that dynamically connects wiring of inputs and outputs.

3. The finite impulse response filter according to claim 2, wherein the wiring variable port has a first terminal provided between each multiplier and a respective delay element, a second terminal provided on output side of the delay element, and a third terminal provided between each multiplier and the adding section, and connects the wiring using the first terminal, the second terminal and third terminal.

4. The finite impulse response filter according to claim 2, further comprising:
a connecting section that outputs a signal input from the adding section corresponding to control of the wiring control section,
wherein each of the N circuit blocks comprises:
a first wiring variable port that outputs an input signal to the delay element and the multiplier;
a second wiring variable port that dynamically connects wiring with the first wiring variable port corresponding to control of the wiring control section, and outputs a signal input from the delay element to the first wiring variable port; and
a third wiring variable port that dynamically connects wiring between the multiplier and the adding section corresponding to control of the wiring control section, and outputs a signal input from the multiplier to the adding section.

5. The finite impulse response filter according to claim 4, wherein the first wiring variable port has N first terminals that are provided corresponding to respective multipliers and respective delay elements of the N circuit blocks, and outputs input signals to the multipliers and the delay elements via the first terminals,
the second wiring variable port has N second terminals that are provided corresponding to the respective delay elements of the N circuit blocks, connects wiring between the second terminals and the first terminals corresponding to control of the wiring control section, and outputs signals input from the delay elements to the first wiring variable port via the second terminals, and
the third wiring variable port has N third terminals that are provided corresponding to the respective multipliers of the N circuit blocks, connects wiring between the third terminals and the adding section corresponding to control of the wiring control section, and outputs signals input from the multipliers to the adding section.

6. The finite impulse response filter according to claim 1, wherein the wiring control section calculates a discrete number of an input signal based on the frequency bandwidth of the input signal detected in the bandwidth detecting section, determines the number of parallels of a filter structure based on the calculated discrete number of the input signal and the number of taps after filtering processing, and controls wiring of inputs and outputs of the N circuit blocks so as to obtain the determined filter structure.

7. The finite impulse response filter according to claim 1, wherein the wiring control section increases the number of parallels in a filter structure by L times when the frequency bandwidth of a discrete input signal increases by L times (L is a natural number), while decreasing the number of parallels in a filter structure by 1/L times, when the frequency bandwidth decreases by 1/L times.

8. The finite impulse response filter according to claim 1, further comprising:
a multiplexing section that multiplexes a plurality of signal lines processed in parallel to a single signal line when a parallel filter structure is provided.

9. The finite impulse response filter according to claim 1, wherein the multiplier is set for a tap coefficient corresponding to impulse response of a route nyquist filter or a nyquist filter.

10. The finite impulse response filter according to claim 1, wherein an integrated circuit that is reconstructed by program is used.

11. The finite impulse response filter according to claim 1, wherein a digital signal processor whose circuit configuration is reconstructed by program is used.

12. The finite impulse response filter according to claim 1, wherein a switched capacitor filter that switches a plurality of capacitors with different capacitances to vary tap coefficients and an integrated circuit or a digital signal processor each enabling reconstruction are used.

13. A communication reception apparatus comprising:
a finite impulse response filter according to claim 1;
a decision section that makes a decision on a signal subjected to filtering processing to generate bit data; and
a phase determining section that determines a phase on which the decision section makes a decision, based on the signal subjected to filtering processing.

14. The communication reception apparatus according to claim 13, further comprising:
a frequency conversion section that performs frequency conversion on a modulation signal transmitted from a communicating party to obtain a baseband signal, wherein the finite impulse response filter receives the baseband signal subjected to the frequency conversion as an input signal.

15. The communication reception apparatus according to claim 13, further comprising:
a quadrature demodulation section that performs quadrature demodulation on a modulation signal transmitted from a communicating party to obtain an in-phase component and a quadrature component of baseband signal,
wherein the finite impulse response filter receives the in-phase component and the quadrature component of baseband signal as input signals.

16. A finite impulse response filter that varies a frequency bandwidth corresponding to an input signal subjected to 2ⁿ-times (n is a positive number) oversampling, comprising:
N circuit blocks each having a multiplier that multiplies an input signal by a tap coefficient set in advance, an adder that receives as its input a multiplication result by the multiplier, and a delay element that delays an addition result by the adder;
a bandwidth detecting section that detects a frequency bandwidth from the input signal; and
a wiring control section that dynamically controls connections of wiring connecting the delay element and an adder of another circuit block corresponding to the detected bandwidth.

17. The finite impulse response filter according to claim 16, further comprising:
a connecting section that outputs a signal input corresponding to control of the wiring control section;
a first wiring variable port that outputs an input signal to the adder, and receives 0 as its input corresponding to control of the wiring control section; and
a second wiring variable port that outputs a signal input from the delay element to the connecting section, while further outputting the signal to the first wiring variable port by dynamically connecting wiring with the first wiring variable port corresponding to control of the wiring control section.

18. The finite impulse response filter according to claim 17, wherein the first wiring variable port has N first terminals that are provided corresponding to respective adders of the N circuit blocks, and outputs input signals to the adders via the first terminals, and
the second wiring variable port has N second terminals that are provided corresponding to respective delay elements of the N circuit blocks, connects wiring between the second terminals and the first terminals corresponding to control of the wiring control section, and outputs signals input from the delay elements to the first wiring variable port via the second terminals.
